(19) United States
(12) Patent Application Publication
(10) Pub. No.: US 2023/0148319 A1
(43) Pub. Date: May 11, 2023

(54) METHOD AND DEVICE WITH CALCULATION FOR DRIVING NEURAL NETWORK MODEL

(71) Applicants: SAMSUNG ELECTRONICS CO., LTD., Suwon-si (KR); Seoul National University R&DB Foundation, Seoul (KR)

(72) Inventors: Sungjoo YOO, Seoul (KR); Seungyeop KANG, Seoul (KR)

(73) Assignees: SAMSUNG ELECTRONICS CO., LTD., Suwon-si (KR); Seoul National University R&DB Foundation, Seoul (KR)

(21) Appl. No.: 17/883,817

(22) Filed: Aug. 9, 2022

(30) Foreign Application Priority Data
Nov. 11, 2021 (KR) 10-2021-0154767

(51) Int. Cl. G06N 3/04

(52) U.S. Cl. CPC G06N 3/04

(57) ABSTRACT

A device includes: one or more processors configured to perform a first operation for driving one or more basic blocks of a neural network model and a second operation for driving one or more transition blocks of the neural network model to drive the neural network model, wherein, for the performing of the first operation, the one or more processors are configured to: perform first batch normalization on input data; quantize the first batch normalized input data; perform a convolution operation based on the quantized input data; determine output data by applying an activation function to a result of the convolution operation; and perform the first operation by performing second batch normalization on the output data.

### CROSS-REFERENCE TO RELATED APPLICATIONS

This application claims the benefit under 35 USC § 119(a) of Korean Patent Application No. 10-2021-0154767, filed on Nov. 11, 2021 in the Korean Intellectual Property Office, the entire disclosure of which is incorporated herein by reference for all purposes.

### BACKGROUND

### 1. Field

The following description relates to a method and device with calculation for driving an artificial neural network (ANN) model.

### 2. Description of Related Art

A convolutional neural network, which is implemented in the field of artificial intelligence (Al), may have a higher performance than other Al technologies. However, when a convolutional artificial neural network (ANN) is deepened and widened to be trained with more data and achieve high performance, a size of a model of the convolutional ANN may be increased, and an operation time may increase based on the number of operations used for processing.

To resolve such issues, a method may reduce a size of a convolutional ANN. For example, there may be a method of designing a structure of the convolutional ANN to be slim (or lightweight), a method of training in which branches of an ANN are pruned, and a method of quantizing a value of a weight into fewer bits (n-bit quantization).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a device includes: one or more processors configured to perform a first operation for driving one or more basic blocks of a neural network model and a second operation for driving one or more transition blocks of the neural network model to drive the neural network model, wherein, for the performing of the first operation, the one or more processors are configured to: perform first batch normalization on input data; quantize the first batch normalized input data; perform a convolution operation based on the quantized input data; determine output data by applying an activation function to a result of the convolution operation; and perform the first operation by performing second batch normalization on the output data.

The one or more basic blocks may include: a first batch normalization layer; a quantization layer; a convolution layer; an active layer; and a second batch normalization layer.

The one or more transition blocks may include: a pooling layer; a channel upscaling layer; and a third batch normalization layer.

The activation function may include a rectified linear unit (ReLU) function.

For the quantizing, the one or more processors may be configured to apply a sign function on the first batch normalized input data, binarize the input data, and perform the first operation.

For the quantizing, the one or more processors may be configured to apply a step function on the first batch normalized input data, quantize the input data, and perform the first operation.

The one or more basic blocks may include a residual connection that connects the input data to the second batch normalized output data.

For the performing of the second operation, the one or more processors may be configured to: perform pooling on output data of the one or more basic blocks; duplicate a channel of the neural network model; and perform the second operation by performing third batch normalization on input data of the neural network model in which the channel is duplicated.

For the performing of the pooling, the one or more processors may be configured to perform average pooling on the output data of the one or more basic blocks.

In another general aspect, a processor-implemented method includes: a first operation for driving one or more basic blocks of a neural network model and a second operation for driving one or more transition blocks of the neural network model to drive the neural network model, wherein the first operation may include: performing first batch normalization on input data; quantizing the first batch normalized input data; performing a convolution operation based on the quantized input data; determining output data by applying an activation function on a result of the convolution operation; and performing second batch normalization on the output data.

The one or more basic blocks may include: a first batch normalization layer; a quantization layer; a convolution layer; an active layer; and a second batch normalization layer.

The one or more transition blocks may include: a pooling layer; a channel upscaling layer; and a third batch normalization layer.

The activation function may include a rectified linear unit (ReLU) function.

The quantizing may include applying a sign function on the first batch normalized input data, binarizing the input data, and performing the first operation.

The quantizing may include applying a step function on the first batch normalized input data, quantizing the input data, and performing the first operation.

The one or more basic blocks may include a residual connection that connects the input data to the second batch normalized output data.

The second operation for driving the one or more transition blocks may include: performing pooling on output data of the one or more basic blocks; duplicating a channel of the neural network model; and performing a second operation by performing third batch normalization on input data of the neural network model in which the channel is duplicated.

In another general aspect, one or more embodiments include a non-transitory computer-readable storage medium storing instructions that, when executed by one or more processors, configure the one or more processors to perform any one, any combination, or all operations and methods described herein.

In another general aspect, a method includes: performing a first neural network operation by: performing first batch normalization on input data; quantizing the first batch normalized input data; performing a convolution operation based on the quantized input data; determining output data by applying an activation function to a result of the convolution operation; and performing second batch normalization on the output data; and performing a second neural network operation based on the second batch normalized output data by performing any one or any combination of a pooling, a channel upscaling, and a third batch normalization.

The pooling may include performing pooling on the second batch normalized output data, the channel upscaling may include duplicating a channel of the pooled output data, and the third batch normalization may include performing third batch normalization on the pooled output data in which the channel is duplicated.

The pooling may include performing downsampling on a width and height of the second batch normalized output data.

The method may include: performing the first neural network operation a plurality of times, wherein the second neural network operation is performed based on a result of the performing of the first neural network a plurality of times.

Other features and aspects will be apparent from the following detailed description, the drawings, and the claims.

### BRIEF DESCRIPTION OF THE DRAWINGS

FIG. 1A illustrates an example of a deep learning calculation method using an artificial neural network (ANN).

FIG. 1B illustrates an example of data and a filter of an input feature map provided as an input in a deep learning operation.

FIG. 1C illustrates an example of performing a deep learning-based convolution operation.

FIG. 2 illustrates an example of a structure of an ANN model.

FIG. 3 illustrates an example of a method of operating a basic block.

FIG. 4 illustrates an example of a method of operating a transition block.

FIG. 5 illustrates an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art, after an understanding of the disclosure of this application, may be omitted for increased clarity and conciseness.

Although terms of “first” or “second” are used to explain various members, components, regions, layers, or sections, these members, components, regions, layers, or sections are not limited to the terms. Rather, these terms should be used only to distinguish one member, component, region, layer, or section from another member, component, region, layer, or section. For example, a “first” member, component, region, layer, or section referred to in examples described herein may also be referred to as a “second” member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

The terminology used herein is for the purpose of describing particular examples only and is not to be limiting of the present disclosure. As used herein, the singular forms “a”, “an”, and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, integers, steps, operations, elements, components, numbers, and/or combinations thereof, but do not preclude the presence or addition of one or more other features, integers, steps, operations, elements, components, numbers, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

Examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, examples will be described in detail with reference to the accompanying drawings. When describing the examples with reference to the accompanying drawings, like reference numerals refer to like components and a repeated description related thereto will be omitted.

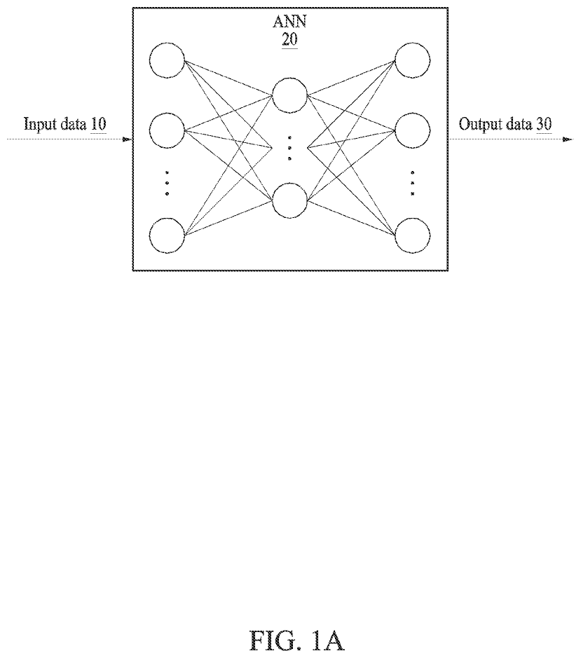

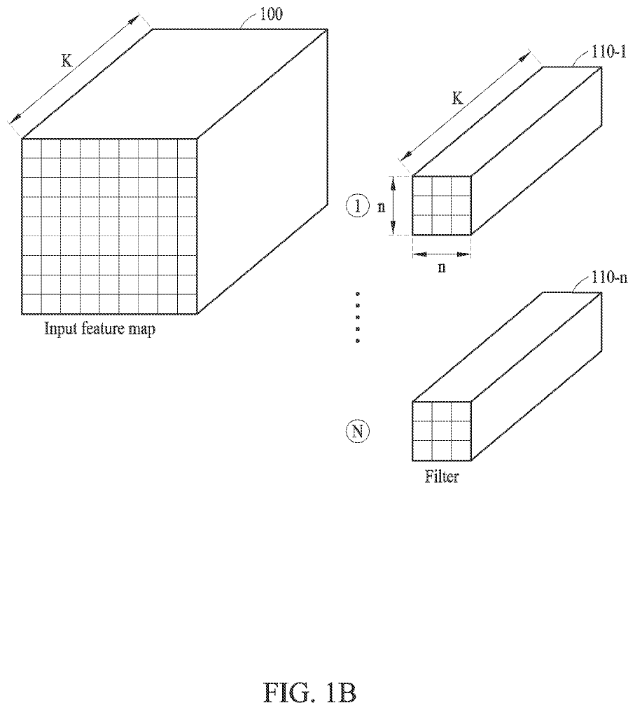

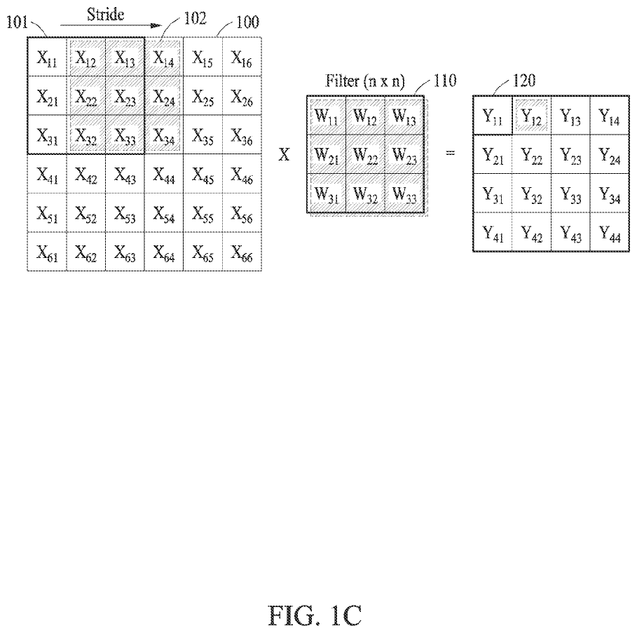

FIG. 1A illustrates an example of a method of performing deep learning operations using an artificial neural network (ANN).

An artificial intelligence (Al) algorithm including deep learning may input input data 10 to the ANN and learn output data 30 through an operation, for example, a convolution operation. The ANN may be a computational architecture obtained by modeling. In the ANN, nodes may be connected to each other and collectively operate to process input data. Various types of neural networks may include, for example, a convolutional neural network (CNN), a recurrent neural network (RNN), a deep belief network (DBN), or a restricted Boltzmann machine (RBM), but are not limited thereto. In a feed-forward neural network, nodes may have links to other nodes. The links may be expanded in a single direction, for example, a forward direction, through a neural network. While the network may be referred to as an “artificial neural network”, such reference is not intended to impart any relatedness with respect to how the network computationally maps or thereby intuitively recognizes information and how a biological brain operates. I.e., the term “artificial neural network” is merely a term of art referring to the hardware-implemented network.

Referring to FIG. 1A, an example of a structure in which the input data 10 is input to the ANN and the output data 30 is output through the ANN (e.g., a CNN 20) including one or more layers is illustrated. The ANN may be, for example, a deep neural network (DNN) including two or more layers.

The CNN 20 may be used to extract “features” (for example, a border, a line, and/or a color) from the input data 10. The CNN 20 may include a plurality of layers. Each of the layers may receive data, process data input to a corresponding layer, and generate data that is to be output from the corresponding layer. Data output from a layer may be a feature map generated by performing a convolution operation on an image or a feature map that is input to the CNN 20 and weight values of one or more filters. Initial layers of the CNN 20 may operate to extract features of a relatively low level (for example, edges or gradients) from an input. Subsequent layers of the CNN 20 may gradually extract more complex features (for example, an eye or a nose) in an image.

FIG. 1B illustrates an example of data and a filter of an input feature map provided as an input in a deep learning operation.

Referring to FIG. 1B, an input feature map 100 may be a set of numerical data or pixel values of an image input to an ANN, but is not limited thereto. In FIG. 1B, the input feature map 100 may be defined by pixel values of a target image that is to be trained using the ANN. For example, the input feature map 100 may have 256×256 pixels and a depth with a value of K. However, such values are merely provided as examples, and a size of the pixels of the input feature map 100 is not limited thereto.

N filters, for example, filters 110-1 to 110-n, may be formed. Each of the filters 110-1 to 110-n may include n by n (or n×n) weights. For example, each of the filters 110-1 to 110-n may have 3×3 pixels and a depth value of K. However, the size of each of the filters 110-1 to 110-n is merely provided as an example and is not limited thereto.

FIG. 10 illustrates an example of performing a deep learning-based convolution operation.

Referring to FIG. 10, the process of performing a convolutional operation in an ANN may be the process of generating, in each layer, output values through a multiplication and addition (MAC) operation between an input feature map 100 and a filter 110, and generating an output feature map 120 using a cumulative sum of the output values.

The process of performing the convolution operation may include performing multiplication and addition operations by applying a preset size, that is, the filter 110 of an n×n size to the input feature map 100 from the upper left to the lower right in a current layer. Hereinafter, a process of performing a convolution operation using the filter 110 of a 3×3 size is described.

For example, firstly, an operation of multiplying 3×3 pieces of data in a first region 101 on the upper left side of the input feature map 100 by weight values w11 to w33 of the filter 110, respectively, is performed. Here, the 3×3 pieces of data in the first region 101 may be a total of nine pieces of data x₁₁ to x₃₃ including three pieces of data related to a first direction and three pieces of data related to a second direction. Thereafter, 1-1 output data y₁₁ in the output feature map 120 may be generated using a cumulative sum of the output values of the multiplication operation, where the output values of the multiplication operation are x₁₁×w₁₁, x₁₂×w₁₂, x₁₃×w₁₃, X₂₁×W₂₁, X₂₂×W₂₂, X₂₃×W₂₃, X₃₁×W₃₁, X₃₂λW₃₂, and x₃₃×w₃₃.

Thereafter, an operation may be performed whereby the filter 110 is moved by a unit of data from the first region 101 to a second region 102 on the upper left side of the input feature map 100. In this example, the number of pieces of data shifted in the input feature map 100 for a convolution operation process is referred to as a stride, and a size of the output feature map 120 to be generated may be determined based on the stride. For example, when the stride is 1, an operation of multiplying a total of nine pieces of input data x₁₂ to x₃₄ included in the second region 102 by the weights W₁₁ to W₃₃ of the filter 110 may be performed, and 1-2 output data y₁₂ in the output feature map 120 may be generated using a cumulative sum of the output values of the multiplication operation, where the output values of the multiplication operation are x₁₂×w₁₁, x₁₃×w₁₂, x₁₄×w₁₃, x₂₂×w₂₁, x₂₃×w₂₂, x₂₄×w₂₃, x₃₂×w₃₁, x₃₃×w₃₂, and X₃₄×x₃₃.

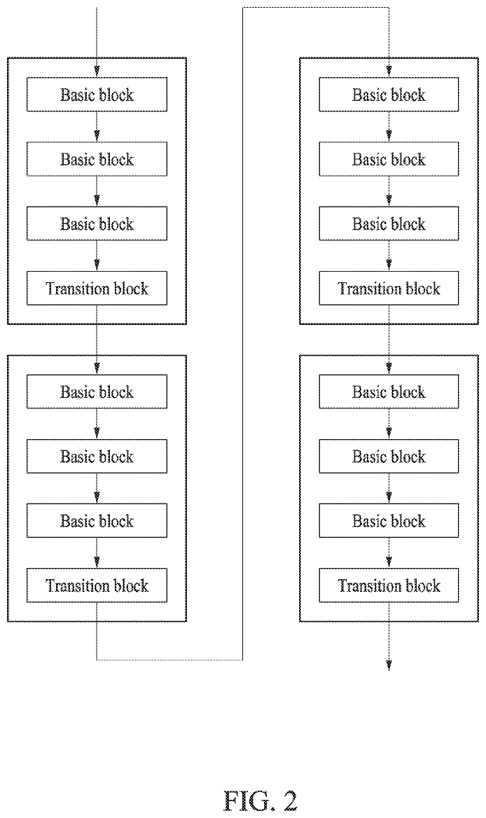

FIG. 2 illustrates an example of a structure of an ANN model.

A typical lightweight neural network may include a binary ANN. While a binary ANN may significantly increase a speed of an existing ANN and reduce a memory capacity of an ANN model, information loss may occur due to existing floating point weights and activation functions being expressed as −1 and 1. Such information loss of the typical lightweight neural network may result in an accuracy decline, thereby bringing a performance degradation when an object is being recognized or detected.

For example, when the typical lightweight neural network maps positive numbers 1.4 and 0.2 to 1 because they are positive numbers, and such two values different in magnitude by 7 times are mapped to the same value, a quantization error may become extremely large. Thus, a binary quantization may be performed considering the magnitude of data using a scale factor in a typical binary ANN to reduce the quantization error. However, the scale factor may also need to be determined through time consuming training. In addition, since a scale-invariant feature is used, a depth may not be scalable in the typical binary ANN.

In contrast, an ANN model of one or more embodiments may be scalable to depth, and information loss may be reduced without using a scale factor.

Referring to FIG. 2, an example of an ANN model is illustrated. The ANN model may be formed by a combination of one or more basic blocks and one or more transition blocks.

That is, the ANN model may be formed by a plurality of unit blocks, and a unit block may be formed by a combination of one or more basic blocks and one or more transition blocks. However, as illustrated in FIG. 2, the ANN model may be formed by four unit blocks, and a unit block may include three basic blocks and one transition block, but the ANN model is not limited thereto. The number of unit blocks forming the ANN model may be changed, and the number of basic blocks and transition blocks may be changed.

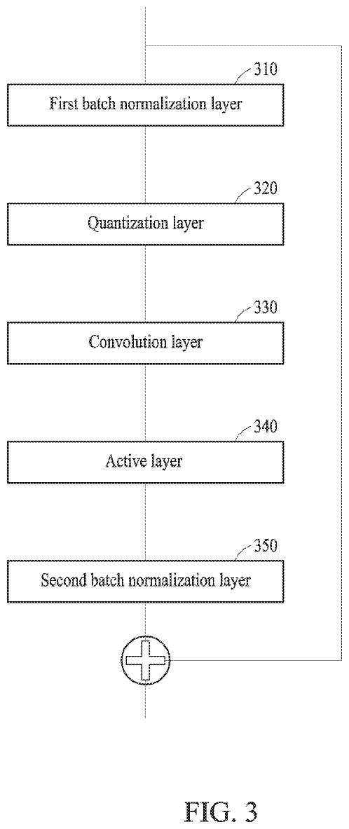

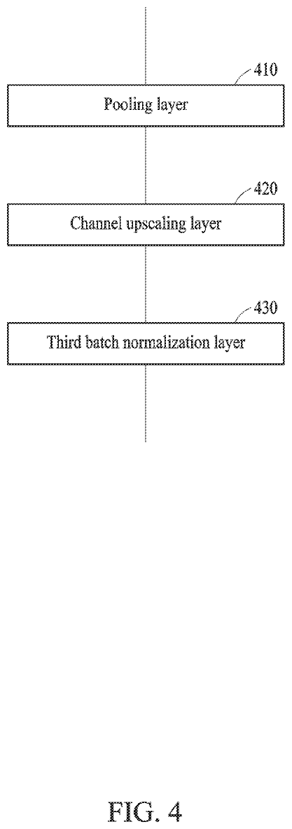

Hereinafter, a non-limiting example method of operating a basic block is described in detail with reference to FIG. 3, and a non-limiting example method of operating a transition block is described in detail with reference to FIG. 4.

FIG. 3 illustrates an example of a method of operating a basic block.

Referring to FIG. 3, a basic block may include a first batch normalization layer 310, a quantization layer 320, a convolution layer 330, an active layer 340, and a second batch normalization layer 350.

In an example, the first batch normalization layer 310 may stabilize a distribution of input data. The input data may include any one of an input feature map and a weight.

For example, a gradient descent may generally use all training data to update a gradient once. Thus, the ANN model may be updated once by obtaining the gradient for all training data and averaging all the gradients. However, processing a large amount of data at once may not be easily done with such a method, and thus data may be divided into batch units for training.

When training is performed in batches, an interval covariant shift in which a distribution of the input data is different for each layer may occur in the training process. That is, a batch normalization layer (e.g., the first batch normalization layer 310) may be used to resolve the difference in data for each batch.

Batch normalization may be a normalization using an average and a variance for each batch even when the data for each batch unit has various distributions, and the batch normalization layer may be a layer performing batch normalization.

The quantization layer 320 may quantize first batch normalized input data. The first batch normalized input data may be input data stabilized through the first batch normalization layer 310.

The quantization layer 320 may binarize the input data by applying a sign function to the first batch normalized input data. When the first batch normalized input data is a positive number, the quantization layer 320 may map the first batch normalized input data to 1, and when the first batch normalized input data is a negative number, the quantization layer 320 may map the first batch normalized input data to −1 by applying the sign function to the first batch normalized input data. In another example, the quantization layer 320 may quantize input data by applying a step function to the first batch normalized input data.

The convolution layer 330 may be a layer performing a convolution operation described with reference to FIG. 10. For example, the convolutional layer 330 may be a 3×3 convolutional layer.

The active layer 340 may be a layer converting a weighted sum of input data into output data using an activation function. For example, the active layer 340 may output 0 when the input data is less than 0 using a rectified linear unit (ReLU) function, and the active layer 340 may output existing input data (a linear function) when the input data is greater than 0.

The second batch normalization layer 350 may perform second batch normalization on output data. A basic block may additionally use the second batch normalization layer 350 and generate a stable distribution of output data without a scale factor. In addition, the second batch normalization layer 350 may adjust the distribution of the output data to be zero-centered.

The basic block may include a residual connection connecting the input data to second batch normalized output data. The residual connection may also be referred to as a skip connection or a shortcut connection. The basic block may take existing input data through the residual connection, and only remaining residual information may be additionally learned.

FIG. 4 illustrates an example of a method of operating a transition block.

Referring to FIG. 4, a transition block may include a pooling layer 410, a channel upscaling layer 420, and a third batch normalization layer 430.

Various parameters may be used for handling or processing data of higher dimensions. However, when an excessive number of parameters are present, overfitting may occur in training. Thus, the method of one or more embodiments may reduce a dimension by reducing the number of parameters used in a filter.

A basic block may not change the magnitude of data, and thus a layer that may reduce the magnitude of data may be used such that the ANN model becomes scale-invariant.

The pooling layer 410 may perform downsampling on a width and height of output data of the basic block. For example, the pooling layer 410 may extract an average of values in a determined size by performing average pooling.

The channel upscaling layer 420 may be a channel duplicate layer, which duplicates a channel by a predetermined multiple.

The transition block may reset a variance to 1 through the third batch normalization layer 430.

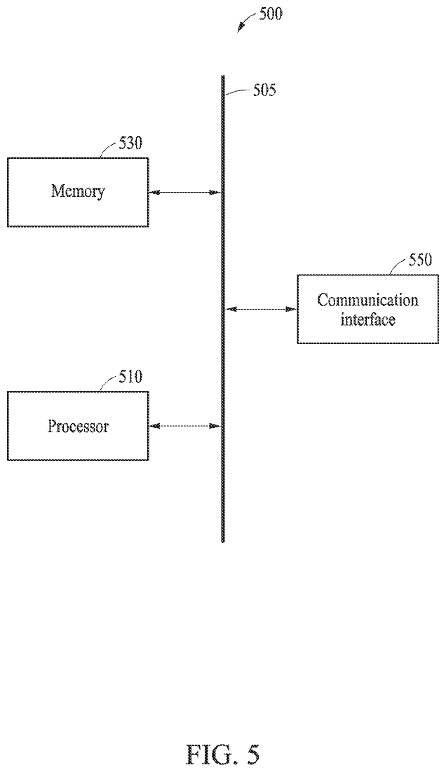

FIG. 5 illustrates an example of an electronic device.

Referring to FIG. 5, a calculation device 500 may include a processor 510 (e.g., one or more processors), a memory 530 (e.g., one or more memories), and a communication interface 550. The processor 510, the memory 530, and the communication interface 550 may communicate with each another through a communication bus 505.

The processor 510 may perform a first operation for driving a basic block and a second operation for driving a transition block. The first operation may include performing first batch normalization on input data, performing binarization and quantization on the first batch normalized input data, performing a convolution operation based on the binarized and quantized input data, determining output data by applying an activation function to convolution operation performance result data, and performing second batch normalization on the output data. The processor may perform any one, any combination of, or all operations and methods described herein with reference to FIGS. 1-4.

The second operation may include performing pooling on the output data of the basic block, duplicating a channel of an ANN model, and performing third batch normalization on input data of the ANN model in which the channel is duplicated.

The memory 530 may be a volatile memory or a non-volatile memory, and the processor 510 may execute a program and control the calculation device 500. Code of the program executed by the processor 510 may be stored in the memory 530. The calculation device 500 may be connected to an external device (e.g., a PC or a network) through an input/output device (not shown) to exchange data therewith. The calculation device 500 may be, be mounted on, or included in various computing devices and/or systems such as a smartphone, a tablet computer, a laptop computer, a desktop computer, a television, a wearable device, a security system, a smart home system, and the like.

The calculation devices, processors, memories, communication interfaces, communication buses, calculation device 500, processor 510, memory 530, communication interface 550, communication bus 505, and other apparatuses, devices, units, modules, and components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A device, the device comprising:
one or more processors configured to perform a first operation for driving one or more basic blocks of a neural network model and a second operation for driving one or more transition blocks of the neural network model to drive the neural network model,
wherein, for the performing of the first operation, the one or more processors are configured to:
perform first batch normalization on input data;
quantize the first batch normalized input data;
perform a convolution operation based on the quantized input data;
determine output data by applying an activation function to a result of the convolution operation; and
perform the first operation by performing second batch normalization on the output data.

2. The device of claim 1, wherein the one or more basic blocks comprise:
a first batch normalization layer;
a quantization layer;
a convolution layer;
an active layer; and
a second batch normalization layer.

3. The device of claim 1, wherein the one or more transition blocks comprise:
a pooling layer;
a channel upscaling layer; and
a third batch normalization layer.

4. The device of claim 1, wherein the activation function comprises:
a rectified linear unit (ReLU) function.

5. The device of claim 1, wherein, for the quantizing, the one or more processors are configured to:
apply a sign function on the first batch normalized input data, binarize the input data, and perform the first operation.

6. The device of claim 1, wherein, for the quantizing, the one or more processors are configured to:
apply a step function on the first batch normalized input data, quantize the input data, and perform the first operation.

7. The device of claim 1, wherein the one or more basic blocks comprise:
a residual connection that connects the input data to the second batch normalized output data.

8. The device of claim 1, wherein, for the performing of the second operation, the one or more processors are configured to:
perform pooling on output data of the one or more basic blocks;
duplicate a channel of the neural network model; and
perform the second operation by performing third batch normalization on input data of the neural network model in which the channel is duplicated.

9. The device of claim 8, wherein, for the performing of the pooling, the one or more processors are configured to:
perform average pooling on the output data of the one or more basic blocks.

10. A processor-implemented method, comprising:
a first operation for driving one or more basic blocks of a neural network model and a second operation for driving one or more transition blocks of the neural network model to drive the neural network model,
wherein the first operation comprises:
performing first batch normalization on input data;
quantizing the first batch normalized input data;
performing a convolution operation based on the quantized input data;
determining output data by applying an activation function on a result of the convolution operation; and
performing second batch normalization on the output data.

11. The method of claim 10, wherein the one or more basic blocks comprise:
a first batch normalization layer;
a quantization layer;
a convolution layer;
an active layer; and
a second batch normalization layer.

12. The method of claim 10, wherein the one or more transition blocks comprise:
a pooling layer;
a channel upscaling layer; and
a third batch normalization layer.

13. The calculation method of claim 10, wherein the activation function comprises:
a rectified linear unit (ReLU) function.

14. The method of claim 10, wherein the quantizing comprises:
applying a sign function on the first batch normalized input data, binarizing the input data, and performing the first operation.

15. The method of claim 10, wherein the quantizing comprises:
applying a step function on the first batch normalized input data, quantizing the input data, and performing the first operation.

16. The method of claim 10, wherein the one or more basic blocks comprise:
a residual connection that connects the input data to the second batch normalized output data.

17. The method of claim 10, wherein the second operation for driving the one or more transition blocks comprises:
performing pooling on output data of the one or more basic blocks;
duplicating a channel of the neural network model; and
performing a second operation by performing third batch normalization on input data of the neural network model in which the channel is duplicated.

18. A non-transitory computer-readable storage medium storing instructions that, when executed by one or more processors, configure the one or more processors to perform the method of claim 10.

19. A method, the method comprising:
performing a first neural network operation by:
performing first batch normalization on input data;
quantizing the first batch normalized input data;
performing a convolution operation based on the quantized input data;
determining output data by applying an activation function to a result of the convolution operation; and
performing second batch normalization on the output data; and
performing a second neural network operation based on the second batch normalized output data by performing any one or any combination of a pooling, a channel upscaling, and a third batch normalization.

20. The device of claim 19, wherein
the pooling comprises performing pooling on the second batch normalized output data,
the channel upscaling comprises duplicating a channel of the pooled output data, and
the third batch normalization comprises performing third batch normalization on the pooled output data in which the channel is duplicated.

21. The method of claim 20, wherein the pooling comprises performing downsampling on a width and height of the second batch normalized output data.

22. The method of claim 19, further comprising:
performing the first neural network operation a plurality of times,
wherein the second neural network operation is performed based on a result of the performing of the first neural network a plurality of times.
